(19) United States
(12) Patent Application Publication
(10) Pub. No.: US 2013/0159164 A1
(43) Pub. Date: Jun. 20, 2013

(54) METHOD AND SYSTEM FOR ANONYMOUSLY MATCHING DEBTORS WITH DEBT HOLDERS TO FACILITATE RESOLUTION OF NON-PERFORMING DEBT

(71) Applicant: Hassan Kassir, Irvine, CA (US)

(72) Inventor: Hassan Kassir, Irvine, CA (US)

(21) Appl. No.: 13/328,167

(22) Filed: Dec. 16, 2011

(51) Int. Cl. G06Q 40/02

(52) U.S. Cl. 705/38

(57) ABSTRACT

A method and system for anonymously matching debtors with debt holders to facilitate resolution of non-performing debt are disclosed. The method and system involve creation of an anonymous debt database such that non-parties to the debt may comply with regulations regarding maintaining confidentiality of debtor information. The anonymous debt database may be made available to be searched by a debtor using one or more anonymous search parameters to identify any debt in the database that is associated with the debtor. The method is designed and adapted to execution on a computer network system.

### CROSS REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### FIELD OF THE INVENTION

The present invention relates generally to the field of debt relief or debt resolution, More particularly, the present invention provides a useful and novel computer network-based method that operates as a third-party proxy/broker for anonymously matching debtors with debt holders and/or third-party investors or debt resolution brokers, employing a user-friendly debtor search engine that maintains the anonymity of the debtors financial information posted by the debt holder parties to the third-party proxy/broker, allowing the debtor to communicate and negotiate with the debt holder or its proxy (such as a collection agency or litigation firm) without updating debtor contact information or releasing any new debtor information, and allowing third party investors and resolution brokers to engage debtor and debt holder in anonymity. A system and technology infrastructure for practicing the method is disclosed.

### BACKGROUND OF THE INVENTION

The existing debt resolution market is in immediate need of a new method of conducting business. Analysis of the existing market reveals fraudulent, abusive, and deceptive practices that pose risks to consumers, and an absence of a market process that best achieves the interests of the debt holders and debtors.

Consumer debt has risen to historic levels. In 2010, credit card debt exceeded $1 trillion, and the charge off rate of non-performing debt reached 10.13%. The result is that over $100 billion of credit card debt, nearly two-thirds of all credit card debt, was charged off in 2010 alone. Add to this other types of unsecured debt, such as charge accounts, medical cost debt, and personal loans, and nearly $175 billion in unsecured debt was charged off in 2010. [Source: Consumer Credit, Federal Reserve Statistical Release; Sep. 8, 2011; <http://www.federalreserve.gov/releases/g19/current/g19.htm>; accessed 30 Sep. 2011]

Charged off debt may either be sold to debt buyers or kept by the debt originators (i.e., banks, credit card companies and other lenders). Hereinafter, both debt buyers and debt originators shall be referred to as debt holders. Debt holders may assign proxies (i.e., debt collection agencies and litigation firms) to collect charged off debt on their behalf. A small percentage of the charged off debt may be collected in the first year (after one or two rounds of collection efforts). The majority of the charged off debt is not collected, since most debtors require years to financially recover sufficiently to able to resolve their charged off debt. During that time, the charged off debt appears on credit reports, thereby damaging the debtors' credit scores. Charged off debt not collected the first year is referred to as aged debt. It is estimated that $150 billion in 2010 charged off debt will be aged debt by 2012. [Source: Charge-Off and Delinquency Rates on Loans and Leases at Commercial Banks; Board of Governors of the Federal Reserve System; Aug. 22, 2011; <http://www.federalreserve.gov/releases/chargeoff/chgallsa.htm>; accessed 30 Sep. 2011] Aged debt may float in the market for years.

Major impediments to effective resolution of debt include: 1) aggressive and abusive debt collection practices, 2) predatory debt settlement industry practices, and 3) legislation designed to curb abusive and predatory practices.

Debt collection agencies and litigation law firms, which represent the debt holder, are effective in reaching out to a significant number of debtors in default. However, their threatening posture and collection methods drive many people away from seeking a reasonable resolution to their debt.

A growing number of for-profit debt settlement companies have emerged. Debt settlement companies reach out to another significant number of debtors, but the debt settlement industry has its own limitations and challenges. Generally, debt settlement companies promise to negotiate, on the debtors behalf, debt settlement agreements with debt holders. For example, debt settlement companies lypically represent that they will settle debt at forty to fifty cents on each dollar owed. In a typical debt settlement services contract, the debtor is required to make monthly payments into an escrow account until there are sufficient funds in escrow to permit the debt settlement service provider to negotiate a one-time settlement payment with the creditors. It may take years for sufficient funds to be accumulated, during which time the negative consequences of past-due debt (credit deterioration, collection activities, potential litigation, etc.) continue. In addition, the past-due debt remains open on the debt holders books. Debt settlement providers often charge a service fee up front, and almost all collect their fees from the escrow account during the first half of the contract, regardless of whether any debt settlement services have been, or will be performed. Debt settlement companies usually advise consumers to stop paying their creditors and to instead set up a special account to build savings that will be used in the future to negotiate a settlement. As the consumer deposits savings into the account, the debt settlement company withdraws money to cover its fees even though it has not reached a settlement with creditors. By stopping payments to creditors, the consumer ends up with a worse credit score, additional penalty fees and more interest charges, and becomes exposed to aggressive collection practices, lawsuits and bankruptcy. An additional disadvantage of current debt settlement industry practice is that, where the debt settlement company takes its fees up front or during the first half of the settlement period, the debt settlement company is not incentivized to reduce the amount of the debt, but merely to establish a payment plan. Further, once the debt settlement company takes its fees, it has little or no incentive even to negotiate any settlement.

In April 2010, the United States General Accountability Office (GAO) reported on its investigation into allegations that debt settlement companies engage in fraudulent, abusive, or deceptive practices that leave consumers in worse financial condition than they occupied before engaging the services of the debt settlement companies. The GAO concluded that “some debt settlement companies engage in fraudulent, deceptive, and abusive practices that pose a risk to consumers already in difficult financial situations.” In fact, 17 of the 18 debt settlement companies from which the GAO was able to obtain information “follow a business model that calls for advance fees and stopping payment to creditors—practices that have been identified as abusive and harmful.” Further, the GAO investigation concluded that “most of those [debt settlement companies] we contacted provided information that was deceptive, abusive, or, in some cases, fraudulent” For example, debt settlement companies claimed success rates that the GAO “found suspiciously high—85 percent, 93 percent, even 100 percent.” In contrast, federal and state agencies report success rates in the single digits. Other GAO findings that constitute fraudulent or deceptive practice include guarantees or promises to obtain minimum reductions in debts (typically 40 to 50 cents on the dollar), false representations of membership in industry associations, and indications that the programs are linked to the government or government programs. [Source: Debt Settlement—Fraudulent, Abusive, and Deceptive Practices Pose Risk to Consumers; United States Government Accountability Office; Gregory D. Kutz; Apr. 23, 2010.]

The United States Federal Trade Commission (FTC) reports that nearly two-thirds of consumers who enroll in debt relief services, most of which pay an advanced fee, end up dropping out of the programs within the first three years without getting the help they paid to receive. [Source: FTC Adopts New Rules to Begin Curbing Debt Settlement Industry Abuses; PR Newswire United Business Media Website; Jul. 29, 2010; retrieved Nov. 15, 2010; <http://www.prnewswire.com/news-releases/ftc-adopts-new-rules-to-begin-curbing-debt-settlement-industry-abuses-99568659.html>; accessed 30 Sep. 2011]

The United States Government and its agencies have introduced legislation aimed at eliminating abusive debt collection practices. A number of these measures are aimed at the protection consumer information.

For the purpose of eliminating abusive debt collection practices by debt collectors, to insure that those debt collectors who refrain from using abusive debt collection practices are not competitively disadvantaged, and to promote consistent State action to protect consumers against debt collection abuses, the United States Congress enacted The Fair Debt Collection Practices Act (FDCPA), 15 U.S.C. §§1692-1692p. The FDCPA states that a debt collector may not engage in any conduct the natural consequence of which is to harass, oppress, or abuse any person in connection with the collection of a debt. Such conduct includes, but is not limited to, the publication of a list of consumers who allegedly refuse to pay debts, and the advertisement for sale of any debt to coerce payment of the debt.

In the Fair Credit Reporting Act (FCRA), 15 U.S.C. §1681 et seq., the Congress stated a need to insure that consumer reporting agencies exercise their grave responsibilities with respect for the consumer's rights to privacy. As a result of that need, the FCRA regulates the use and disclosure of consumer financial information such as payment transactions for medical products or services and accounts placed for collection or charged to profit and loss. A consumer reporting agency may provide information about a consumer only to people with a valid need, as determined by the FCRA, usually to consider an application with a creditor, insurer, employer, landlord, or other business.

Subtitle A of Title V of The Gramm-Leach-Bliley Act (GLB Act), Public Law 106402, 15 U.S.C. §6801, et seq., enacted Nov. 12, 1999, contains privacy provisions relating to consumers' financial information. Under these provisions, financial institutions have restrictions on when they may disclose a consumer's personal financial information to nonaffiliated third parties.

Sections 261-264 of The Health Insurance Portability and Accountability Act of 1996 (HIPAA), Public Law 104-191 require the Secretary of the United States Department of Health and Human Services to publicize standards for the electronic exchange, privacy and security of health information. The Department published the final regulation, the Privacy Rule in December 2000. The Privacy Rule protects individually identifiable health information, including the past, present, or future payment for the provision of health care to the individual.

The need to comply with such legislative protections poses a serious challenge to the implementation and operation of network-based debt resolution mechanisms. In particular, any debt resolution process that operates with the involvement of a third-party proxy is hampered by the legal prohibition against the debt holders sharing of individually identifiable data with the third-party proxy.

The debt resolution industry has developed third-party proxy methods to resolve aged debt. For example, U.S. Pat. No. 6,330,551, Burchetta et. al., discloses a computerized system for automated dispute resolution through an Intranet website via the Internet or other communications linkage for communicating and processing a series of demands to satisfy a claim and a series of offers to settle the claim. Another method, disclosed by Kassir in U.S. patent application Ser. No. 12/928,655, employs a computer network-based system and method for communicating and processing offers to restructure debt through third-party debt purchasing. As a result of the legislative constraints on sharing individual debtor information, such methods face the challenge of anonymously matching debtors and debt holders in a third-party proxy system.

What is needed is a method and system for the debt resolution market to bring debtors and creditors together while maintaining the protective anonymity of the debtors, both from the third-party proxy and from the debt holder and/or its proxies.

Collecting on aged floating debt becomes increasingly challenging with time since debtors change their contact information, thereby making it harder for debt holders to locate the debtors and collect on their debt.

Further complicating the aging debt matter, when a debtor, potentially years after default, recovers financially and wants to resolve his/her debt, the debtor may face several challenges. The debtor may not know how to locate the current debt holder. The debtor may be intimidated or afraid that any contact or new information will be used against him/her by collection agencies or litigation firms. The debtor may not wish to help the debt holder to locate him/her. The debtor may not know how to negotiate with a debt holder. The debtor may need the help of a debt resolution broker, such as a debt settlement, debt restructure or debt consolidation company. The debtor may need help from third party investors who may buy the debt at discounted prices and accept payments from the debtor. Further, the debtor may even have outstanding debt that he/she is unaware of or that they have completely forgotten.

What is needed is a method and system to reach out to the debtors who are not reached by the debt market participants (collection agencies and debt settlement companies), who may be intimidated or repelled by the adversarial nature of the interaction with these market participants, or who are left with their debt matters unresolved by their experiences with debt market participants.

### SUMMARY OF THE INVENTION

In view of the foregoing limitations and disadvantages inherent to the known methods and systems in the related art, the present invention [hereinafter “anonymous debtor match (ADM)”] provides a novel and useful computer network-based method of matching debtors with debt holders, employing a user-friendly debtor match search engine that maintains anonymity of the debtor and the debtors personally-identifying information to a third-party proxy.

Specifically, the anonymous debtor match method (hereinafter “ADM method”), and its computer network-based system, compiles and publishes an anonymous database that may be searchable by debtors using one or more anonymous search parameters. The ADM method facilitates matching debtors with current debt holders for the purpose of enabling resolution of debt. The ADM method may further enable a debtor to anonymously make an offer to a debt holder without providing updated information on the debtor and, thereby, exposing the debtor to renewed debt collection harassment activities.

A principal object and aspect of the present invention is to respond to the need to comply with regulations and legislation, directed to the protection of a debtor's information, by electronically publishing an anonymous debt database that may be searched by a debtor using one or more anonymous search parameters. The debtor may identify his/her debt and access data and information regarding his/her debt, including the identity and contact information of the current debt holder, without third-party proxy knowledge of the debtor's identity and without providing any new information to the debt holder.

A further object and aspect of present invention is to enable debtors who begin to recover financially after years of default, and who desire to resolve debt in default, or who may not be aware of a delinquent debt, to locate and access the data and information necessary to enable them to address those debts. ADM employs new media and technology to reach out to these debtors. ADM may also offer debtors a wealth of information concerning the debt resolution industry and practices, and advertisements for debt resolution services.

Another object and aspect of the present invention is to adapt the ADM method to execution on a computer network system [hereinafter “anonymous debtor match system (ADM system)”]. The ADM method is readily adapted to computer network implementation. Further, the ability to execute the ADM method is integral with, and reliant upon its technology infrastructure in order to create a scalable market and to realize process efficiency advantages. The present invention may transform a general purpose computer/computer network into a specially-designed and configured computer/computer network for the purpose of executing the ADM method. Exemplary embodiments of the enabling ADM system are disclosed herein.

Other objects, aspects and advantages of the present invention will become readily apparent to those with skill in the art from the following figures, descriptions and claims. As will be appreciated by those with skill in the art, the method of the present invention may be implemented in a plurality of equivalent steps, and the system may be implemented in a plurality of equivalent embodiments. Such alternative method steps and system embodiments, and their attendant objects, aspects and advantages, are within the scope of the present invention and, therefore, the examples set forth herein shall not be limiting.

### BRIEF DESCRIPTION OF THE DRAWINGS

The nature of this invention, as well as all its objects, aspects and advantages, will become readily apparent and understood upon reference to the following detailed description when considered in conjunction with the accompanying drawings, in which like reference numerals designate like parts throughout the figures thereof, and wherein:

FIG. 1 presents a flowchart showing the steps of a method for anonymously matching debtors with debt holders to facilitate resolution of non-performing debt, according to one exemplary embodiment of the present invention;

FIG. 2 presents a block diagram of a system for practicing the method of FIG. 1, according to one exemplary embodiment of the present invention; and

FIG. 3 presents a block diagram of a system for practicing the method of FIG. 1, according to alternative embodiments of the present invention.

### DETAILED DESCRIPTION OF THE INVENTION

The following description is provided to enable any person skilled in the art to make and use the invention, and sets forth the best modes contemplated by the inventor of carrying out the invention. The present invention shall not be limited to the examples disclosed. Rather, the scope of the invention shall be as broad as the claims will allow.

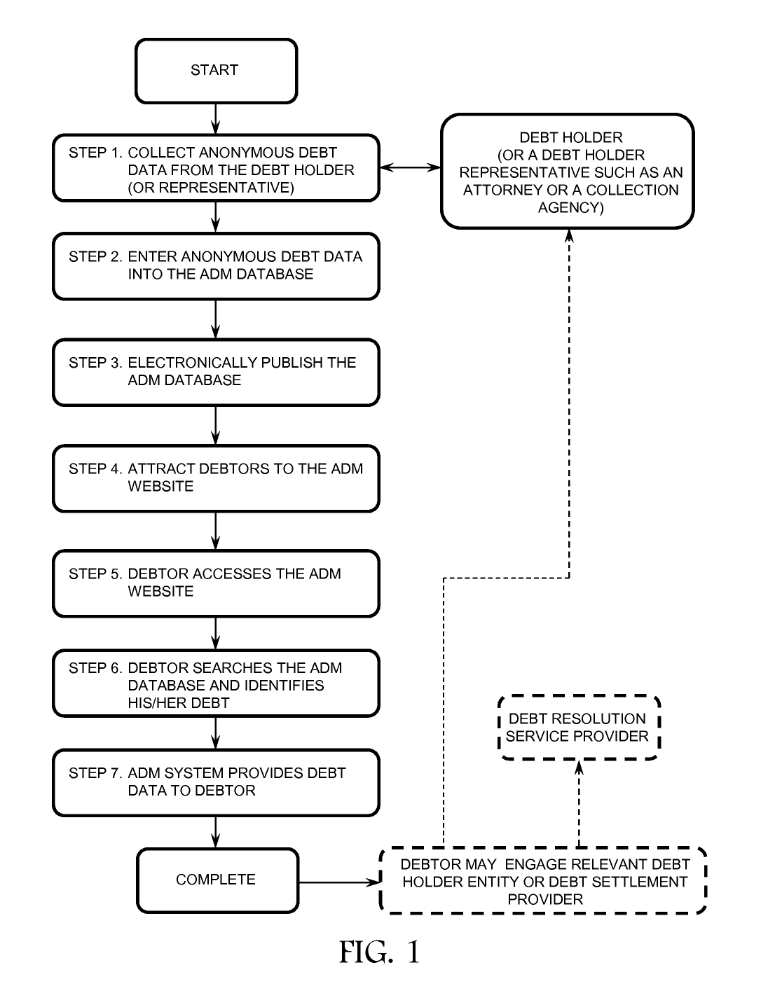

Referring now to the drawings, FIG. 1 presents a flowchart showing the steps according to one preferred embodiment of the ADM method.

Step 1. An ADM service provider, by means of an ADM system 10, may collect anonymous debt data from The debt holder community. This data may include information identifying the debt holder; such as the current debt holder's name and contact information. This data may include information concerning the debt, such as the debt account number and a history of debt ownership and transactions. The collection of anonymous debt data may be achieved by the ADM service provider approaching debt holders, and soliciting their participation in the ADM method. Alternatively, debt holders may initiate their involvement in the ADM method by contacting the ADM service provider. No data may be collected that would identify a debtor to a third-party, such as the ADM service provider. Instead, one or more anonymous search parameters may be selected that will be known by the debtor and will allow a debtor to identify his/her debt, such as the last four digits of the debtor's Social Security Number. These parameters may be included in the data collected from the debt holder community.

Step 2. The collected anonymous debt data may be entered into an anonymous debtor match database (ADM database) 52, which may be connected to an anonymous debtor match search engine (ADM search engine) 50 via an anonymous debtor match application programming interface (ADM API) 54, and may be designed to be searchable using the selected one or more anonymous search parameters. The anonymous debt data may be entered into the ADM database 52 by the ADM service provider, or the debt holder may post the anonymous debt data directly to the anonymous debtor match network server (ADM network server) 30. Alternatively, the anonymous debt data may be hosted on a debt holder's server (not shown) that may be searchable by the ADM search engine 50.

Step 3. The ADM database 52 may be electronically published via an anonymous debtor match website (ADM website) 34 and may be made available to be searched by debtors by means of the ADM search engine 50. Alternatively, in the case where the anonymous debt data is be hosted on a debt holders server, the debt holder may accept ADM searches directly into their database via the ADM API 54.

Step 4. The ADM service provider may attract debtor traffic to the ADM website 34 using marketing tools including, but not limited to, new media tools such as social networking sites and webpage contextual mining and markup applications.

Step 5. A debtor may access the ADM service through the ADM website 34.

Step 6. The debtor may search the ADM database 52 by means of the ADM search engine 50 and, employing the selected one or more anonymous search parameters, identify his/her debt.

Step 7. The ADM system 10 may provide the debtor with his/her debt data that may be stored in the ADM database 52. The debt data may be received by the debtor network terminal 60. The debt data may include information identifying the debt holder, such as the current debt holder's name and contact information. The debt data may include information concerning the debt, such as the debt account number and a history of debt ownership and transactions. The debt data may be supplemented with information regarding the debt resolution industry and its practices. The supplemental information may further include advertisements for debt resolution services. The ADM method may now be complete.

Now in possession of his/her current debt data, the debtor may elect to engage the current debt holder directly or to enlist the services of a debt resolution service provider.

In an alternative embodiment of the ADM method, a debt holder may interface with the ADM system 10 by means of an interactive automated telecommunications application 32. In this alternative embodiment, any or all of Steps 1-2 may be executed by means of the automated telecommunication application 32.

In another alternative embodiment of the ADM method, a debtor may interface with the ADM system 10 by means of an interactive automated telecommunications application 32. In this alternative embodiment, any or all of Steps 3-7 may be executed my means of the automated telecommunication application 32.

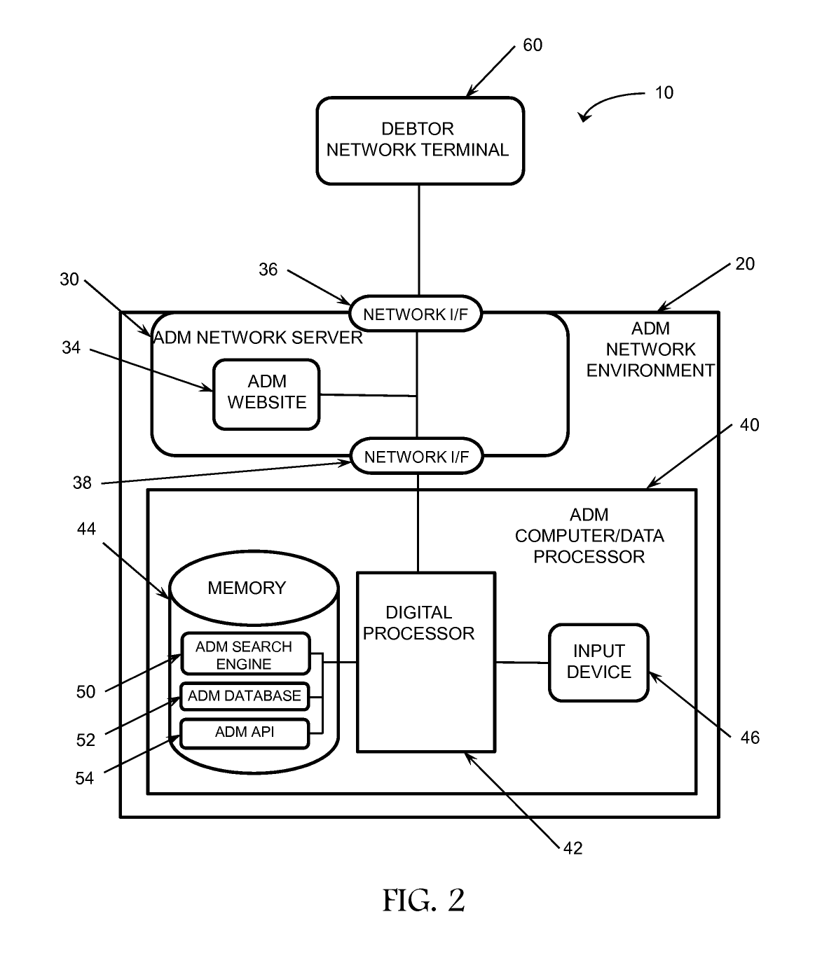

FIG. 2 presents a block diagram of one exemplary embodiment of a system for implementing the computer network-based ADM method. An ADM system 10 may comprise one or more debtor network terminals 60 and an automated debtor match network environment (ADM network environment) 20. The one or more debtor network terminals 60 may be configured to enable one or more debtor to interface with the ADM network environment 20. A network terminal may be a personal computer, a tablet computer, a smart phone, or other device that may be used for entering and/or displaying data into, and displaying data. The ADM network environment 20 may comprise an ADM network server and an automated debtor match computer/data processor (ADM computer/data processor) 40.

The ADM computer/data processor 40 may comprise a digital processor 42, a memory 44 and an input device 46. The memory 44 may host an ADM database 52, an ADM search engine 50, and an ADM API 54.

Anonymous debt data may be entered into the ADM database 52 by means of the input device 46. The input device 46 may be a data entry keyboard, a stored or transmitted database, or any other useful means or device for entering information and/or data. The digital processor 42 may execute instructions from the ADM search engine 50 and the ADM API 54. The ADM search engine 50 may be designed and configured to enable a debtor to access and search the ADM database 52. The ADM API 54 may be designed and configured to provide the interface between ADM software applications and the client (debtor and/or debt holder) systems, applications and databases.

The ADM network server 30 may host an ADM website 34, and have a first network interface 36, and a second network interface 38. The ADM website 34 may serve as the portal through which debt holders and debtors may access the ADM system 10 and search the ADM database 52. The first network interface 36 may provide the communication interface between the ADM network environment 20 and the one or more debtor network terminals 60. In one exemplary embodiment, the first network interface 36 may be the Internet. The second network interface 38 may provide the communication interface between the ADM computer/data processor 40 and the ADM network server 30. In one exemplary embodiment, the second network interface 38 may be the Internet. In an alternative embodiment, the ADM website 34 may be hosted on a server outside of the ADM network environment 20.

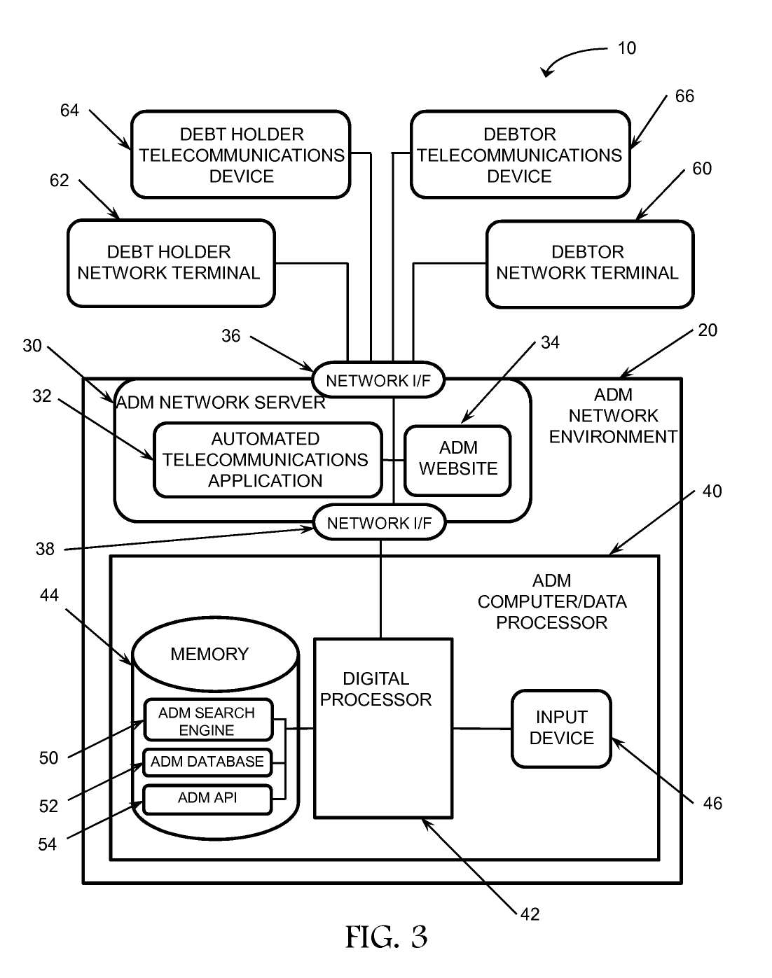

FIG. 3 presents a block diagram of alternative exemplary embodiments of a system for implementing the computer network-based ADM method. In one alternative embodiment, the ADM system 10 may further comprise one or more debt holder network terminals 62 configured to enable one or more debt holders to interface with the ADM network environment 20. Steps 1-2 of the ADM method may be accomplished by means of the interface between the debt holder network terminal 62 and the ADM network environment 20.

In another alternative embodiment, the ADM system 10 may further comprise one or more debtor telecommunications devices 66, such as telephones or smart phones, and an automated telecommunications application 32. A debtor telecommunications device 66 may be configured to enable a debtor to interface with the automated telecommunications application 32 of the ADM system 10. In this alternative embodiment, any or all of Steps 3-7 of the ADM method may be executed by means of the debtor telecommunications device 66. The automated telecommunications application 32 may be designed and configured to execute any or all of Steps 3-7 of the ADM method.

In yet another alternative embodiment, the ADM system 10 may further comprise one or more debt holder telecommunications devices 64, such as telephones or smart phones, and an automated telecommunications application 32. The debt holder telecommunications device 64 may be configured to enable a debt holder to interface with the automated telecommunications application 32 of the ADM system 10. In this alternative embodiment, any or all of Steps 1-2 of the ADM method may be executed my means of the debt holder telecommunications device 64. The automated telecommunications application 32 may be designed and configured to execute any or all of Steps 1-2 of the ADM method.

Alternative embodiments of the ADM system 10 may include any combination of debtor network terminals 60, debtor telecommunications devices 66, debt holder network terminals 62, and/or debt holder telecommunications devices 64.

The method and/or system of the present invention may be useful in applications and fields other than debt relief or debt resolution. Any application wherein it may be useful to anonymously match parties and/or data is within the intended scope of the present invention.

The individual steps of the disclosed method may be modified, interchanged, separated or combined, or additional steps added without departing from the spirit of the invention. Further, the elements of the system for practicing the disclosed method may be modified, interchanged, separated or combined, or additional elements added without departing from the spirit of the invention. The invention may be practiced in alternative embodiments other than IS those illustrated in the Figures. Such modifications, combinations, additions and alternatives are within the contemplation of the present invention. The exemplary method and embodiments disclosed are not intended to limit the scope of this invention. Accordingly, the scope of the invention should be determined not by the embodiments illustrated, but by their legal equivalents, and shall be as broad as the claims will allow.

What is claimed is:

1. A computer network-based method designed to anonymously match debtors with debt holders, comprising:
a) collecting anonymous debt data, including one or more anonymous search parameters, from at least one debt holder;
b) entering said anonymous debt data into a database designed to be searchable using said one or more anonymous search parameters;
c) electronically publishing said database;
d) attracting a debtor to a third-party proxy website;
e) said debtor accessing said third-party proxy website;
f) said debtor searching said database using said one or more anonymous search parameters and identifying debt data associated with said debtor; and
g) providing said debtor with said debt data associated with said debtor.

2. The computer network-based method according to claim 1, wherein a portion of said debtor's Social Security Number is one of said one or more anonymous search parameters.

3. The computer network-based method according to claim 1, wherein social networking websites are used to attract a debtor to said third-party proxy website.

4. The computer network-based method according to claim 1, wherein webpage contextual mining and markup applications are used to attract a debtor to said third-party proxy website.

5. A computer network-based system for anonymously matching debtors with debt holders, comprising:
at least one debtor network terminal designed and configured to communicate with a network environment;
a network environment, comprising:
a computer/data processor, comprising:
a digital processor designed and configured to process computer executable programs;
a digital memory designed and configured to store computer executable programs and data, said digital memory comprising a program storage device readable by a machine, tangibly embodying a program of instructions executable by the machine to perform the method of claim 1, 2, 3 or 4;
an input device designed and configured to input commands and data into said digital processor and said digital memory;
a database designed and configured to store data and to be searchable using one or more search parameters;
a search engine designed and configured to enable a person to search said database using said one or more search parameters; and
an application programming interface designed and configured to enable communication between software components; and
a network server designed and configured to host a debt matching website, said network server comprising:
a first network interface designed and configured to provide a communication link between said network server and said at least one debtor network terminal; and
a second network interface designed and configured to provide a communication link between said network server and said computer/data processor;
said computer network-based system being designed and configured to:
collect anonymous debt data from at least one debt holder;
enter said anonymous debt data into a database designed and configured to be searchable using anonymous parameters;
electronically publish said database;
attract a debtor to a third-party proxy website;
enable said debtor to access said third-party proxy website;
enable said debtor to search said database using one or more anonymous search parameters and to identify debt data associated with said debtor; and
provide said debtor with said debt data associated with said debtor.

6. The computer network-based system according to claim 5, wherein:
said computer network-based system further comprises at least one debt holder terminal; and
said network server further comprises a network interface designed and configured to provide a communication link to said at least one debt holder terminal.

7. The computer network-based system according to claim 5, wherein:
said computer network-based system further comprises:
at least one debt holder telecommunication device; and
an automated telecommunications software application;
and
said network server further comprises a network interface designed and configured to provide a communication link to said at least one debt holder telecommunication device.

8. The computer network-based system according to claim 5, wherein:
said computer network-based system further comprises:
at least one debtor telecommunications device; and
an automated telecommunications software application;
and
said network server further comprises a network interface designed and configured to provide a communication link to said at least one debt holder telecommunication device.

9. A computer network-based system for anonymously matching debtors with debt holders, said computer network-based system comprising:
a means for collecting anonymous debt data from at least one debt holder;
a means for entering said anonymous debt data into a database designed and configured to be searchable using anonymous parameters;
a means for electronically publishing said database;
a means for attracting a debtor to a third-party proxy website;
a means for enabling said debtor to access said database;
a means for enabling said debtor to search said database using one or more anonymous search parameters and to identify debt data associated with said debtor; and
a means for providing said debtor with said debt data associated with said debtor.
